(19) United States
(12) Patent Application Publication
(10) Pub. No.: US 2025/0265608 A1
(43) Pub. Date: Aug. 21, 2025

(54) MACHINE LEARNING-ENABLED INPUTS FOR OPTIMIZATION OF SUPPLY-DEMAND IN A MANAGED MARKETPLACE SYSTEM

(71) Applicant: Maplebear Inc., San Francisco, CA (US)

(72) Inventors: Frank Erickson, San Francisco, CA (US); Soren Zeliger, Oakland, CA (US); Parikshit Verma, College Station, TX (US); Dmitry Shkolnik, San Francisco, CA (US); Xiangyu Wang, San Jose, CA (US); Aman Jain, Seattle, WA (US)

(21) Appl. No.: 18/443,103

(22) Filed: Feb. 15, 2024

(51) Int. Cl. G06Q 30/0202; G06Q 10/0631

(52) U.S. Cl. CPC G06Q 30/0202; G06Q 10/06315

(57) ABSTRACT

In accordance with one or more aspects of the disclosure, a managed marketplace analyzes marketplace statistics across different sub-markets to identify a target supply-demand ratio for each sub-market that balances the degree of supply (e.g., for a service such as product delivery) with the degree of consumer demand so as best to achieve a balance of different objectives. In each of various sub-markets, metric values are generated by corresponding prediction models for each of the supply-demand ratios for that sub-market, and the metric values are combined into a single score to determine how well that particular supply-demand ratio achieves the overall objectives of the managed marketplace. For each sub-market, the candidate supply-demand ratio leading to the greatest score is selected as the target ratio. Policies of one or more downstream subsystems are adjusted so as to shift the current supply-demand ratio of the sub-market toward the target optimal supply-demand ratio.

### BACKGROUND

Digital marketplaces facilitate the exchange of goods and services between buyers and sellers using electronic devices. Imbalances of supply and demand within a marketplace can degrade marketplace health. For example, an excess of demand for goods leads to the marketplace being unable to provide buyers with all the products or services that they are seeking; conversely, an excess of supply of goods leads to wasted costs due to excessive product inventories. In the case of marketplaces in which services are additionally provided (e.g., delivery services for purchased goods), an excess of demand for the service similarly leads to the marketplace being unable to keep up with consumer demand for the service, and an excess of supply of the service leads to reduced opportunities for the suppliers of those services, leading to a decline in supplier morale, exits from the marketplace, or the like.

To the extent that the marketplace has the ability to influence the levels of supply and demand, it would be desirable to be able to do so to effect a relative balance, but determining the proper balance, and the actions required to achieve that balance within the marketplace, is difficult. This difficulty is greatly compounded by the existence of different sub-markets within the overall marketplace, each such market having its own innate characteristics such as structural labor market conditions, preferences of customers, preferences of service providers (e.g., those shopping on behalf of customers), density and urban structure, and many other unique features. As a result, the optimal relationship between supply and demand will inevitably vary due to the underlying characteristics of each individual sub-market. Further, these idiosyncratic differences occur not only across regions, but also over time due to weekly and monthly seasonality. All of these innate differences make it difficult to identify a single optimal target supply-demand ratio suitable for all sub-markets.

Supply-demand balancing could be accomplished by treating it as an optimization problem, but such optimization would require data representing the various metrics that are components of an objective function for optimization, and such data are not readily available.

### SUMMARY

In accordance with one or more aspects of the disclosure, a managed marketplace analyzes marketplace statistics across different sub-markets to identify a target supply-demand ratio for each sub-market that balances the degree of supply (e.g., for a service such as product delivery) with the degree of consumer demand so as best to achieve an optimized balance of different objectives.

To this end, machine-learned prediction models are obtained and/or trained; the models correlate supply-demand ratios with expected values for corresponding metrics that are components of the objective function. The expected values can accordingly be used for optimization, as follows. Various candidate supply-demand ratios are generated for each sub-market. In each sub-market, a plurality of metric values are generated by the corresponding prediction models for each of the supply-demand ratios for that sub-market, and the metric values are combined into a single score to determine how well that particular supply-demand ratio achieves the overall objectives of the managed marketplace, as embodied in an objective function. For each sub-market, the candidate supply-demand ratio leading to the greatest score is selected as the target optimal ratio for that sub-market. The policies—such as the granting of incentives, or the waitlisting of marketplace users—of one or more downstream subsystems are adjusted so as to shift the current supply-demand ratio of the sub-market toward the target optimal supply-demand ratio.

The techniques disclosed herein create a greater balance between consumers and service providers within individual, potentially disparate sub-markets of an overall managed marketplace. This results in a healthier market with greater satisfaction for both consumers and providers.

Although examples are provided herein of shopping marketplaces in which shoppers obtain and deliver products on behalf of customers (the “supply” and “demand” being with respect to the service of shopping), the techniques disclosed herein are applicable to all manner of different managed marketplaces for goods and services in which the marketplace can affect the relative levels of supply and demand.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates components of the market-shaping module of FIG. 2, according to some embodiments.

FIG. 4 is a data flow diagram illustrating actions taken by the market-shaping module of FIG. 2 when determining and bringing about a desired supply-demand ratio for a particular sub-market, according to some embodiments.

FIG. 5 is a flowchart of steps for determining and achieving an optimal supply-demand score for a sub-market, according to some embodiments.

### DETAILED DESCRIPTION

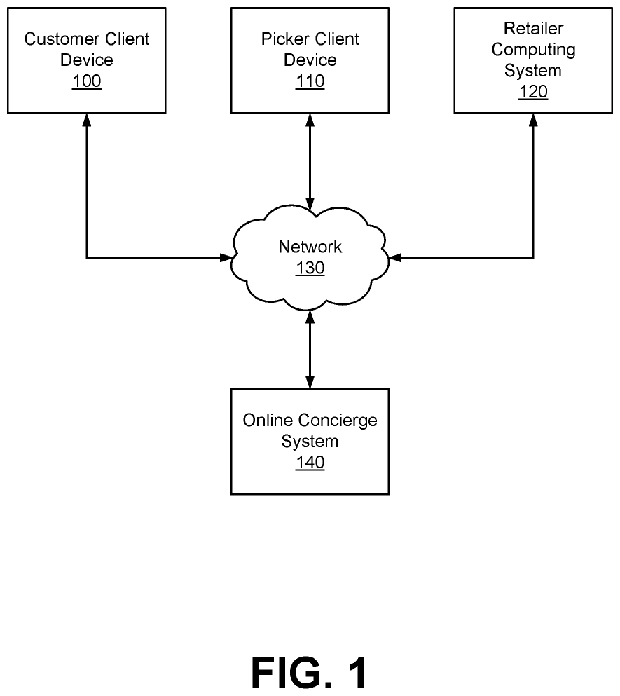

FIG. 1 illustrates an example system environment for an online concierge system 140, in accordance with one or more embodiments. The online concierge system 140 provides one example of a managed marketplace, in which shoppers (or “pickers”) provide the service of shopping for and delivering products to customers. The degree of supply of services in such a marketplace represents the degree to which shoppers have made themselves available for performing shopping on behalf of customers, and the degree of demand for such services represents the degree to which customers wish for shoppers to perform shopping and delivery services on their behalf.

The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

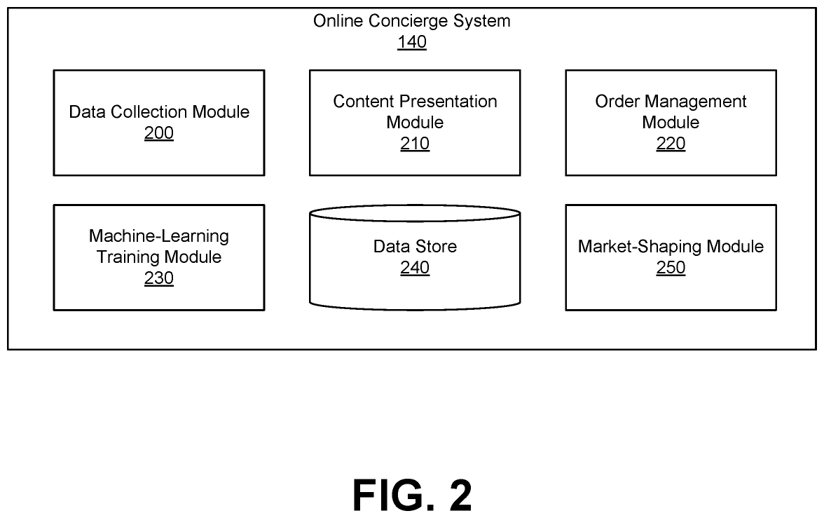

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The online concierge system 140 additionally includes a market-shaping module 250 that analyzes logged data for the various sub-markets within the managed marketplace, estimates optimal ratios of supply and demand within those sub-markets, and takes actions calculated to influence the degrees of supply and demand in those sub-markets to achieve those optimal ratios. Ratio optimality is evaluated according to an objective function that combines a number of different metrics, such as conversions, costs, and quality, as discussed in more detail below.

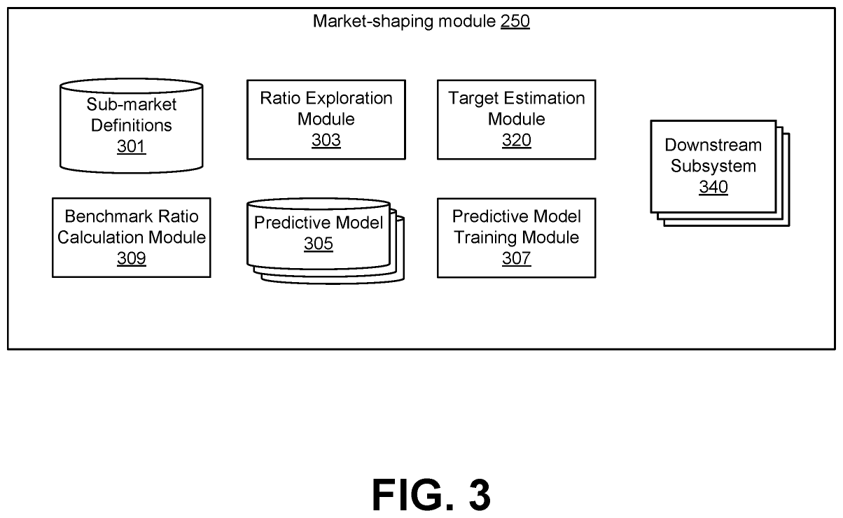

FIG. 3 illustrates components of the market-shaping module 250 of FIG. 2, according to some embodiments.

The market-shaping module 250 includes data providing a set of sub-market definitions 301. The sub-markets demarcate different portions of the overall marketplace with different characteristics, for which different supply-demand ratios are appropriate. In some embodiments, the sub-markets are defined on the basis of geography and/or time. For example, a sub-market can be defined geographically as a particular city, neighborhood within a city, or (more generally) any region definable by locations, such as a geographic region encompassed by a geometric shape defined by latitude and longitude coordinates. (The geographic definition of a sub-market is hereinafter referred to as the sub-market's “geographic zone,” or simply “zone”.) Sub-markets can additionally and/or alternatively be defined by time, given that the supply-demand characteristics of a region can vary according to the day of the week, month of the year, holidays, seasonality, time of day, and the like. As an example of a joint geography-time definition, a particular sub-market might be defined as a particular city between 6 and 9 PM on Saturdays.

In some embodiments, the market-shaping module 250 includes a benchmark ratio calculation module 309 that computes a supply-demand ratio empirically determined to be effective across the marketplace as a whole. In some embodiments, such a benchmark supply-demand ratio is determined based on its ability to produce a given time-to-acceptance (TTA) (the average time for a picker to accept an order submitted by a customer).

The market-shaping module 250 includes a ratio exploration module 303 that determines different candidate supply-demand ratios to be evaluated according to how well they satisfy an objective function defining the goals of the managed marketplace. In some embodiments, the ratio exploration module 303 takes as its starting point a benchmark supply-demand ratio (e.g., that produced by the benchmark ratio calculation module 309). From the starting ratio, the ratio exploration module 303 generates a set of candidate supply-demand ratios. For example, the ratio exploration module 303 can select a number of different candidate supply-demand ratios by multiplying the benchmark ratio by various multiplicative factors. The multiplicative factors may be selected randomly or semi-randomly within a range based on determined sensitivities of downstream subsystems 340. These sensitivities may be determined through an offline analysis of the downstream subsystems.

The market-shaping module 250 has a set of predictive models 305—one set of models for each sub-market—that predict the values for different metrics that will result from different possible supply-demand ratios in the various sub-markets. Each different predictive model 305 corresponds to a different metric. In some embodiments, the metrics include conversions (the rate at which customer “visits” to the managed marketplace—e.g., by visiting its website or using an associated app—lead to customers placing orders with the managed marketplace), cost (how much the managed marketplace must spend to fulfill a customer order), and fulfillment quality (e.g., the speed with which the order is fulfilled, and/or whether the order was delivered later than estimated to the customer).

In some embodiments, the market-shaping module 250 additionally has a predictive model training module 307 that it uses to train the predictive models 305. In some embodiments, gradient-boosted decision trees are used as the foundational models for training. In some embodiments, the features used for training the predictive models 305 include: attributes of the market (day of week; and recent averages of fulfillment cost, storefront conversion rate and late delivery rate for the same zone and day of week); forecasted market conditions (e.g., demand, supply, deliveries per shopper); and points extracted from the estimated shopper-promotion supply curve (e.g., how many incremental deliveries will be generated per dollar of additional spending). Adjustments can be made on top of the foundational models, such as centering the outcome labels by subtracting their recent historical average values. This focuses the model fitting process on capturing the effects of intervention, since only this effect (of choosing one set of multiplication factors versus another) will drive the model's decision. Several features, like “supply gaps”, are determined by the multiplication factors. Specialized code is used to include these novel features in the “pipeline” supported by libraries like scikit-learn. (The pipeline maps from raw data sources and candidate interventions through various operations before training or querying the model.) Compound weights may also be applied to each training data point to ensure that the model performs well against objective metrics. For example, the weights may include transaction volume weights (so that variation in a sub-market's outcomes matters more if it pertains to a larger fraction of the business), recency weights (to emphasize more recent data), and inverse propensity weights (to allow use of all the data without biasing the model).

The market-shaping module 250 additionally includes a target estimation module 320 that—for a given sub-market—computes a supply-demand ratio that will best fulfill the goals of the managed marketplace for that sub-market. The goals are expressed via an objective function, which is computed based on the different possible metrics. More specifically, the target estimation module 320 uses the ratio exploration module 303 to obtain a set of candidate supply-demand ratios to evaluate. For each such candidate ratio, the target estimation module 320 evaluates how well that ratio satisfies the objective function. To evaluate how well the ratio satisfies the objective function, the target estimation module 320 uses each predictive model 305 to obtain a metric score corresponding to a candidate ratio and then combines these scores to obtain the overall objective function result for that candidate ratio. In some embodiments, the combination is by linear combination of weights associated with each metric; the set of weights represents the overall marketplace policy, since it quantifies the relative importance of each metric for the marketplace. With the objective function evaluated (scored) for each candidate ratio, the target estimation module 320 selects the highest-scoring candidate ratio as the target ratio for the sub-market. The target-estimation module 320 is used for each sub-market to select a target ratio for that sub-market.

The market-shaping module 250 additionally has, or has access to, one or more downstream subsystems 340 that it uses to bring about the target ratio for a sub-market, as determined by the target estimation module 320. For example, in some embodiments one type of downstream subsystem 340 is a promotion subsystem that offers vouchers, coupons, or other incentives to users in the sub-market. For instance, the promotion subsystem might increase customer demand by offering a certain discount on product delivery during a certain window of time, or might increase shopper supply by offering shoppers a particularly large commission for performing the shopping. Other downstream subsystems 340 can take actions such as adjusting fees, delivery time windows, or cart-building options. Another type of downstream subsystem 340 might place customers or shoppers on a waitlist to decrease supply and/or demand, or change the amount or type of advertising. Different downstream subsystems may be directed at different time horizons. For example, one downstream system focusing on the shorter-term might offer promotions for orders taking place on same day as the promotion was offered, and a different downstream system focusing on the longer-term might offer promotions for orders taking place on the day after the promotion was offered, waitlist users, or change the degree of advertising. The market-shaping module 250 uses historical data to model the degree to which actions of the various downstream subsystems will influence the supply-demand ratio, so that it can direct the downstream subsystems to take the degree of actions calculated to best bring about the desired supply-demand ratio in the sub-market.

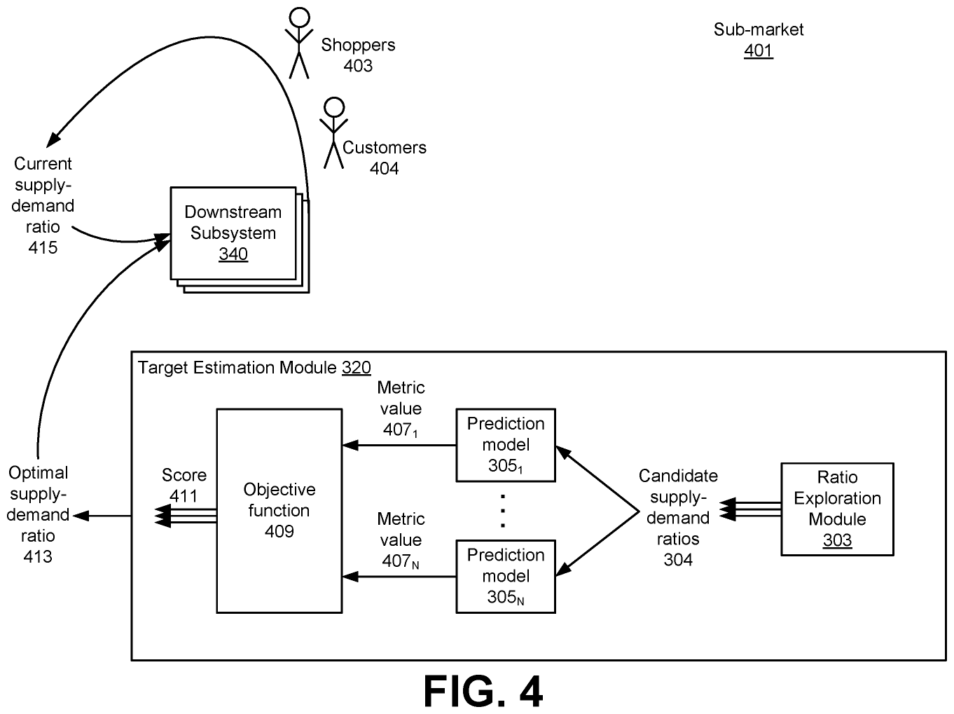

FIG. 4 is a data flow diagram illustrating actions taken by the market-shaping module 250 when determining and bringing about a desired supply-demand ratio for a particular sub-market 401, according to some embodiments. The ratio exploration module 303 produces a number of candidate ratios 304, as discussed above. For each of these candidate ratios 304, each prediction model 305 produces a metric value 407 that quantifies the expected impact of that ratio on the metric in question (e.g., conversions, cost, or quality), and these different metric values 407 are combined to arrive at a final score 411 of the objective function 409 for the candidate ratio 304. The candidate ratio 304 corresponding to the highest of these scores is selected as the optimal supply-demand ratio 413 for the sub-market 401.

The current supply-demand ratio 415 is determined for the sub-market 401 (e.g., by comparing the number of unassigned orders of customers 404 with the number of shoppers 403 who are currently available but not yet assigned to a task). The market-shaping module 250 uses the downstream subsystems 340 to take actions (e.g., the offering of promotions to the customers 404 and/or shoppers 403) calculated to change the current supply-demand ratio 415 to be close to the optimal supply-demand ratio 413.

The results of the use of the downstream subsystems 340 to influence the supply-demand ratio of a sub-market—such as observed fulfillment costs, conversion rates, and/or current supply-demand ratios within the sub-market—can themselves be used to further train the models. This better allows the market-shaping module 250 to continually and automatically adapt over time to changing conditions in the managed marketplace.

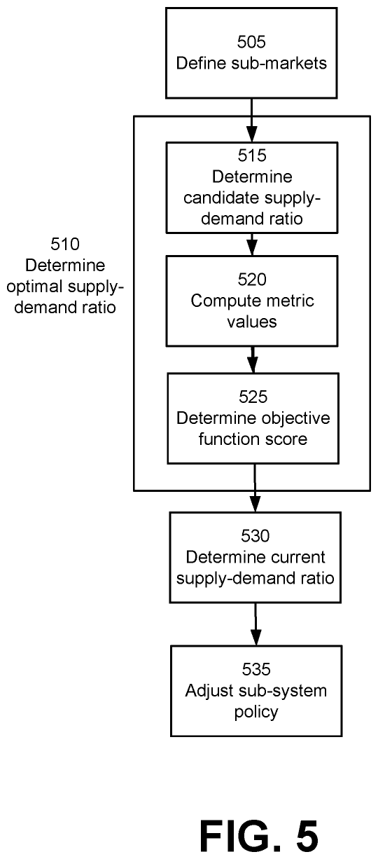

FIG. 5 is a flowchart of steps for determining and achieving an optimal supply-demand score for a sub-market, according to some embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system without human intervention.

In step 505, the sub-markets are defined, e.g., with definitions 301 from FIG. 3.

In step 510, the optimal supply-demand ratio is determined for one of the sub-markets. To determine the optimal supply-demand ratio, in step 515 a plurality of candidate supply demand ratios are determined. In step 520, a plurality of metric values are computed for each of the candidate ratios (e.g., using the predictive models 305), and in step 525, a score for the objective function 409 is determined, based on the metric values, for each of the candidate ratios. The optimal ratio is selected as the highest-scoring of the candidate ratios.

In step 530, the current supply-demand ratio for the sub-market is determined, e.g., as described above for the ratio 415 of FIG. 4. In step 535, a policy of a downstream sub-system 340 is adjusted so as to lead the current supply-demand ratio to the optimal supply-demand ratio for the sub-market.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method performed by a computer system comprising a processor and a computer-readable medium, the method comprising:
defining a plurality of sub-markets within a managed marketplace, each sub-market corresponding to a particular geographic region and a particular range of time;
for each sub-market of the plurality of sub-markets within the managed marketplace, generating an optimal supply-demand ratio that is expected to optimize an objective function with respect to the sub-market, the determining comprising:
using a benchmark supply-demand model to generate a benchmark supply-demand ratio;
generating a plurality of candidate supply-demand ratios based on the benchmark supply-demand ratio;
for each of the plurality of candidate supply-demand ratios:
generating a plurality of metric values using a corresponding plurality of machine-learned prediction models, each prediction model trained to output an expected value of a corresponding metric based on the candidate supply-demand ratio; and
generating an objective function score for the candidate supply-demand ratio as a combination of the plurality of metric values;
for a first sub-market of the plurality of sub-markets:
generating a current supply-demand ratio within the first sub-market; and
adjusting a policy of one or more downstream sub-systems to adjust the current supply-demand ratio within the first sub-market to the generated optimal supply-demand ratio for the first sub-market.

2. The method of claim 1, wherein generating the plurality of candidate supply-demand ratios comprises multiplying the benchmark supply-demand ratio by a plurality of semi-randomly-selected factors.

3. The method of claim 2, wherein generating the plurality of candidate supply-demand ratios further comprises:
determining degrees of sensitivity of the one or more downstream sub-systems; and
determining the plurality of semi-randomly-selected factors at least in part based on the degrees of sensitivity.

4. The method of claim 1, wherein generating the current supply-demand ratio within the first sub-market comprises comparing a number of orders of customers for products that have not yet been assigned for delivery with a number of shoppers currently listed as available to deliver products.

5. The method of claim 1, wherein the objective function score is generated as a weighted combination of the plurality of metric values, each prediction model having a corresponding weight value indicating an importance of the corresponding metric to an overall marketplace objective.

6. The method of claim 1, wherein the one or more downstream sub-systems perform one or more of: offering an incentive to users of the first sub-market, or placing users of the first sub-market on a waiting list.

7. The method of claim 1, further comprising training the prediction models using gradient-boosted decision trees.

8. The method of claim 7, further comprising retraining the prediction models based on observed conditions within the first sub-market following actions of the one or more downstream sub-systems.

9. A non-transitory computer-readable medium storing instructions that, when executed by a processor, cause the processor to perform operations comprising:
defining a plurality of sub-markets within a managed marketplace, each sub-market corresponding to a particular geographic region and a particular range of time;
for each sub-market of the plurality of sub-markets within the managed marketplace, determining an optimal supply-demand ratio that is expected to optimize an objective function with respect to the sub-market, the determining comprising:
using a benchmark supply-demand model to generate a benchmark supply-demand ratio;
generating a plurality of candidate supply-demand ratios based on the benchmark supply-demand ratio;
for each of the plurality of candidate supply-demand ratios:
generating a plurality of metric values using a corresponding plurality of machine-learned prediction models, each prediction model trained to output an expected value of a corresponding metric based on the candidate supply-demand ratio; and
generating an objective function score for the candidate supply-demand ratio as a combination of the plurality of metric values;
for a first sub-market of the plurality of sub-markets:
generating a current supply-demand ratio within the first sub-market; and
adjusting a policy of one or more downstream sub-systems to adjust the current supply-demand ratio within the first sub-market to the generated optimal supply-demand ratio for the first sub-market.

10. The computer-readable medium of claim 9, wherein generating the plurality of candidate supply-demand ratios comprises multiplying the benchmark supply-demand ratio by a plurality of semi-randomly-selected factors.

11. The computer-readable medium of claim 10, wherein generating the plurality of candidate supply-demand ratios further comprises:
determining degrees of sensitivity of the one or more downstream sub-systems; and
determining the plurality of semi-randomly-selected factors at least in part based on the degrees of sensitivity.

12. The computer-readable medium of claim 9, wherein generating the current supply-demand ratio within the first sub-market comprises comparing a number of orders of customers for products that have not yet been assigned for delivery with a number of shoppers currently listed as available to deliver products.

13. The computer-readable medium of claim 9, wherein the objective function score is generated as a weighted combination of the plurality of metric values, each prediction model having a corresponding weight value indicating an importance of the corresponding metric to an overall marketplace objective.

14. The computer-readable medium of claim 9, wherein the one or more downstream sub-systems perform one or more of: offering an incentive to users of the first sub-market, or placing users of the first sub-market on a waiting list.

15. The computer-readable medium of claim 9, the operations further comprising training the prediction models using gradient-boosted decision trees.

16. The computer-readable medium of claim 15, the operations further comprising retraining the prediction models based on observed conditions within the first sub-market following actions of the one or more downstream sub-systems.

17. A system comprising a processor and a non-transitory computer-readable medium storing instructions that, when executed by the processor, cause the processor to perform operations comprising:
defining a plurality of sub-markets within a managed marketplace, each sub-market corresponding to a particular geographic region and a particular range of time;
for each sub-market of the plurality of sub-markets within the managed marketplace, determining an optimal supply-demand ratio that is expected to optimize an objective function with respect to the sub-market, the determining comprising:
using a benchmark supply-demand model to generate a benchmark supply-demand ratio;
generating a plurality of candidate supply-demand ratios based on the benchmark supply-demand ratio;
for each of the plurality of candidate supply-demand ratios:
generating a plurality of metric values using a corresponding plurality of machine-learned prediction models, each prediction model trained to output an expected value of a corresponding metric based on the candidate supply-demand ratio; and
generating an objective function score for the candidate supply-demand ratio as a combination of the plurality of metric values;
for a first sub-market of the plurality of sub-markets:
generating a current supply-demand ratio within the first sub-market; and
adjusting a policy of one or more downstream sub-systems to adjust the current supply-demand ratio within the first sub-market to the generated optimal supply-demand ratio for the first sub-market.

18. The system of claim 17, wherein generating the plurality of candidate supply-demand ratios comprises multiplying the benchmark supply-demand ratio by a plurality of semi-randomly-selected factors.

19. The system of claim 18, wherein generating the plurality of candidate supply-demand ratios further comprises:
determining degrees of sensitivity of the one or more downstream sub-systems; and
determining the plurality of semi-randomly-selected factors at least in part based on the degrees of sensitivity.

20. The system of claim 17, wherein generating the current supply-demand ratio within the first sub-market comprises comparing a number of orders of customers for products that have not yet been assigned for delivery with a number of shoppers currently listed as available to deliver products.
